(19) United States
(12) Patent Application Publication
(10) Pub. No.: US 2006/0092859 A1
(43) Pub. Date: May 4, 2006

(54) Method, apparatus, and medium for automatically configuring network address

(75) Inventors: Hyun-seok Choi, Seoul (KR); Pyung-soo Kim, Seoul (KR); Choon-kyoung Moon, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/254,787

(22) Filed: Oct. 21, 2005

(30) Foreign Application Priority Data
Oct. 28, 2004 (KR) 10-2004-0086544

(51) Int. Cl. H04L 12/28; H04L 12/56

(52) U.S. Cl. 370/254; 370/389

(57) ABSTRACT

An apparatus, method, and medium of automatically configuring a network address are provided. The method of configuring an address of one of a plurality of nodes on a subnet, the method comprising the operations of: obtaining an ID of the subnet from a packet transmitted from a router on the subnet; and configuring an address that none of the nodes on the subnet use as an address of the node among addresses including the obtained subnet ID. Accordingly, an IP address of the node can be automatically and unmistakably (correctly) configured in the current network environment in which performing packet sniffing is difficult.

### CROSS-REFERENCE TO RELATED APPLICATIONS

This application claims the benefit of Korean Patent Application No. 10-2004-0086544, filed on Oct. 28, 2004, in the Korean Intellectual Property Office, the disclosure of which is incorporated herein in its entirety by reference.

### BACKGROUND OF THE INVENTION

1. Field of the Invention

The present invention relates to a method, apparatus, and medium for configuring a network address, and more particularly, to a method, apparatus, and medium for automatically configuring a network address.

2. Description of the Related Art

FIG. 1 is a view showing a conventional network environment.

Referring to FIG. 1, the conventional network environment includes a gateway 1, and node A 11, node B 12, node C 13, and node D 14. The node A 11, node B 12, node C 13 and node D 14 are connected to one another through a LAN 10, and connected to an external network such as Internet 20 through the gateway 1.

Nodes on a network have a network address to identify themselves on the network. The network address is typically an IP (Internet protocol) address. An IP address is composed of a subnet ID and a node ID. In general, a subnet is a grouping of nodes connected to the external network through a single gateway 1, and nodes on the same subnet, for example, the node A 11, node B 12, node C 13, and node D 14, have an identical subnet ID.

Once an IP address is configured, fixed computers such as the node A 11, node B 12, and node C 13 can continuously use the IP address. However, in a mobile computer such as the node D 14, since a subnet is changed each time the mobile computer moves, the IP address has to be newly reconfigured.

There are generally three methods of configuring an IP address. First, a computer user can inquire of a network manager about an IP address, and manually configure the IP address provided by the network manager. However, this method is complicated because every time the IP address is reconfigured, the computer user should make an inquiry to the network manager and manually configure the IP address.

Secondly, a network address can be automatically configured through a DHCP (Dynamic Host Configuration Protocol) server. However, this method cannot be used in an environment in which the DHCP server does not exist.

The third method is to automatically configure a network address without the assistance of a network manager or a DHCP server. In particular, Korean Patent Publication No. 2003-0048931, which is a typical conventional art relating to this method, uses a statistical method. That is, according to this prior art, an IP address is automatically configured by obtaining a subnet ID based on a statistically more frequent ARP (Address Resolution Protocol) packet among the ARP packets which are obtained by packet sniffing. However, since this method is based on a statistical result, the IP address can be mistakenly configured. In particular, this method uses a ping packet to obtain an available IP address. However, in the current network environment, the number of nodes that do not use a ping response service to avoid hacking is increasing and it is difficult to perform packet sniffing. Thus, the method is not suitable to the current network environment.

### SUMMARY OF THE INVENTION

The present invention provides a method, an apparatus, and a medium by which an IP address of a node can be automatically and unmistakably (correctly) configured without the assistance of a network manager and a DHCP server in the current network environment in which performing packet sniffing is difficult.

The present invention also provides a computer readable recording medium having embodied thereon a computer program for executing the method.

According to an aspect of the present invention, there is provided a method of configuring an address of one of a plurality of nodes on a subnet, the method comprising the operations of: obtaining an ID of the subnet from a packet transmitted from a router on the subnet; and configuring an address that none of the nodes on the subnet use as an address of the node among addresses including the obtained subnet ID.

According to another aspect of the present invention, there is provided an apparatus for configuring an address of a node on a subnet, the apparatus comprising: a subnet ID obtaining portion obtaining an ID of the subnet from a packet transmitted from a router on the subnet; and an address configuring portion configuring an address that none of nodes on the subnet use as an address of the node among addresses including the obtained subnet ID.

According to still another aspect of the present invention, there is provided a computer readable recording medium having embodied thereon a computer program for executing the method of configuring an address of one of a plurality of a node on a subnet.

According to an aspect of the present invention, there is provided a method of configuring an address of one of a plurality of nodes on a subnet, comprising obtaining a subnet ID of the subnet from a packet on the subnet; and configuring an address that none of the nodes on the subnet use, as the address of the one node among addresses including the obtained subnet ID.

According to an aspect of the present invention, there is provided at least one computer readable medium storing instructions that control at least one processor to perform a method of configuring an address of a plurality of nodes on a subnet, the method comprising obtaining an ID of the subnet from a packet on the subnet; and configuring an address that none of the nodes on the subnet use, as the address of the one node among addresses including the obtained subnet ID.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a view showing a conventional network environment;

FIG. 2 is a view showing a network environment to which the present invention is applied;

FIG. 3 is a configuration diagram of an IP address configuring apparatus according to an exemplary embodiment of the present invention;

FIG. 4 is a diagram illustrating a format of a RIPv2 packet used for an exemplary embodiment of the present invention;

FIG. 5 is a diagram illustrating a format of an OSPF hello packet used for an exemplary embodiment of the present invention; and

FIG. 6 is a flowchart illustrating a method of configuring an IP address according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

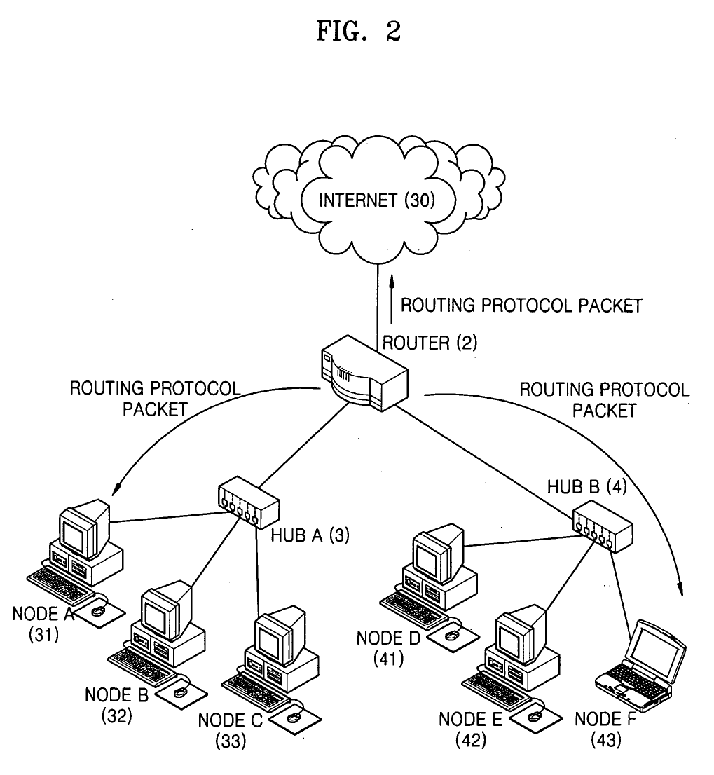

FIG. 2 is a view showing a network environment to which the present invention is applied.

Referring to FIG. 2, a network environment includes a router 2, a hub A 3, hub B 4, and node A 31, node B 32, node C 33, node D 41, node E 42, and node F 43. Node A 31, node B 32, and node C 33 are interconnected with the hub A 3, selectively connected with the router 2 by switching of the hub A 3, and connected with an external network such as Internet 30 through the router 2. Therefore, the router 2 may be a kind of gateway, and most gateways have a routing function.

The router 2 uses a distinct routing protocol, which is typically a Routing Information Protocol (RIP) or an Open Shortest Path First (OSPF), to provide an efficient routing service. A router using the RIP transmits an entire routing table to hosts around the router every 30 seconds, and the hosts re-transmit the table to the peripheral hosts. Such transmission is continued until all hosts in a network have the same routing table. The RIP has no problems in a small network, but in a large network, transmitting the entire routing table every 30 seconds greatly burdens the network. The OSPF was developed to solve the problem of the RIP, and a router using the OSPF transmits a changed part of a routing table when the change occurs.

The routing protocols cyclically check changes in a network and update the routing table, accordingly. To this end, the routing protocols cyclically transmit a routing protocol packet such as a RIPv2 packet or an OSPF hello packet, as shown in FIG. 2.

The nodes connected to the external network through the router 2, that is, the node A 31, node B 32, node C 33, node D 41, node E 42, and node F 43 form a single subnet and have the same subnet ID.

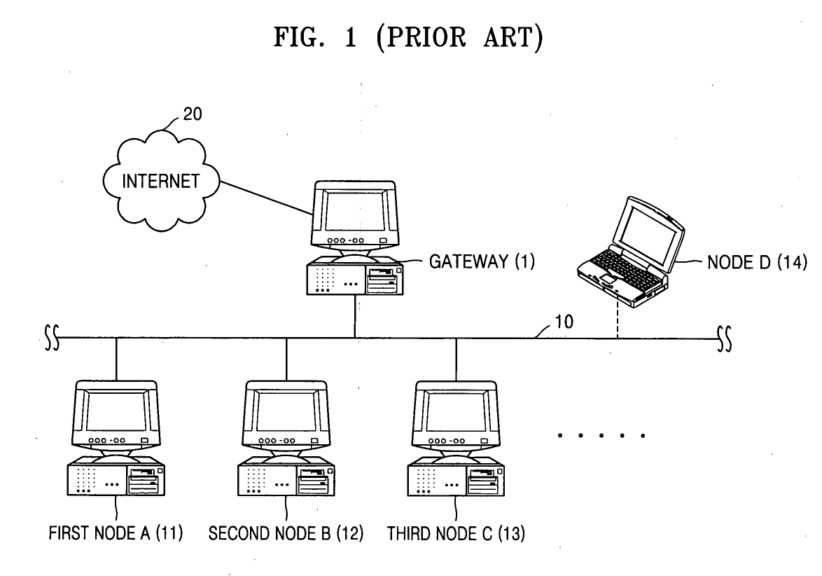

When the conventional network environment shown in FIG. 1 is compared with the network environment shown in FIG. 2, all nodes in the subnet of the conventional network environment shown in FIG. 1 are physically interconnected with one another. Thus, even when a node unicasts a packet to a predetermined node, all the nodes as well as the predetermined node can receive the packet and sniff the packet.

However, as shown in FIG. 2, in the network environment, not all nodes on the subnet are physically interconnected with one another in order to efficiently use network bandwidth. That is, only the nodes to be communicated with each other are interconnected by the switching of the hubs 3 and 4. Therefore, in the network environment as shown in FIG. 2 for example, it is nearly impossible to sniff a packet being transmitted to another node, and it is also nearly impossible to configure an IP address in the network environment shown in FIG. 2 using the conventional art which employs the packet sniffing.

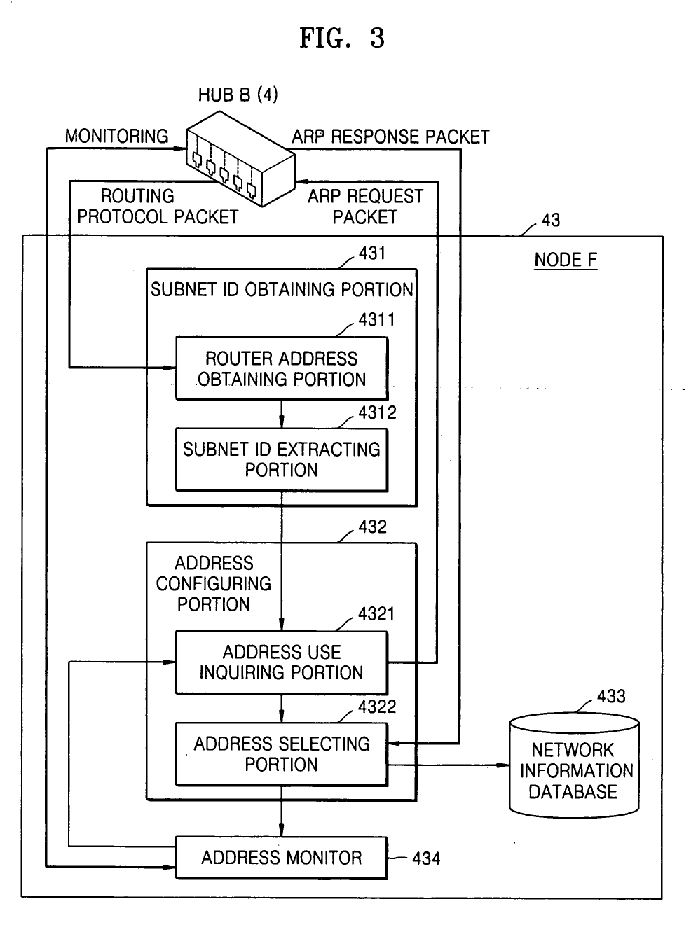

FIG. 3 is a configuration diagram of an IP address configuring apparatus of the node F 43 according to an exemplary embodiment of the present invention.

Referring to FIG. 3, the IP address configuring apparatus includes a subnet ID obtaining portion 431, an address configuring portion 432, a network information database 433, and an address monitor 434.

The subnet ID obtaining portion 431 obtains an ID of the subnet from a routing protocol packet transmitted from the router 2. As described above, the routing protocol packet is a packet which the router 2 broadcasts to all nodes connected to the router 2 in order to cyclically check changes in the subnet according to the routing protocol such as the RIP and the OSPF.

The subnet ID obtaining portion 431 includes a router address obtaining portion 4311 and a subnet ID extracting portion 4312.

The router address obtaining portion 4311 obtains an IP address of the router 2 by monitoring the routing protocol packet input to the node F 43 using packet sniffing. The packet sniffing in exemplary embodiments is different from the conventional art in that the conventional packet sniffing can sniff packets transmitted to other nodes but the packet sniffing in exemplary embodiments of the present invention can sniff only a packet transmitted to a designated node. Since the routing protocol packet is broadcasted to all nodes connected to the router 2, the node F 43 can sniff it.

The subnet ID extracting portion 4312 extracts the ID of the subnet from the IP address of the router 2, which has been obtained by the router address obtaining portion 4311. How the subnet ID obtaining portion 431 obtains the subnet ID will now be described in detail using the currently used routing protocol packets as an example.

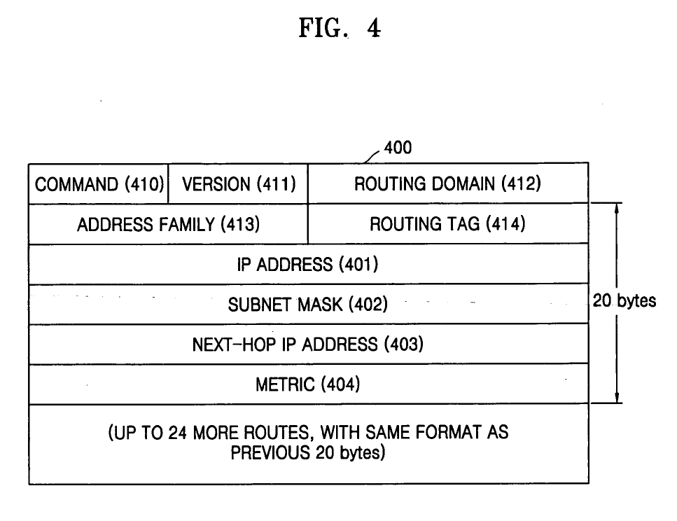

FIG. 4 is a diagram illustrating a format of a RIPv2 packet 400 used in an exemplary embodiment of the present invention.

Referring to FIG. 4, the RIPv2 packet 400 includes a command field 410, a version field 411, a routing domain field 412, an address family field 413, a routing tag field 414, an IP address field 401, a subnet mask field 402, a next-hop IP address field 403, a metric field 404, etc.

In the present exemplary embodiment, the IP address field 401 and the subnet mask field 402 are used to obtain the subnet ID. The IP address of the router is recorded in the IP address field 401, and a subnet mask for extracting the subnet ID from the IP address is recorded in the subnet mask field 402.

That is, the router address obtaining portion 4311 reads the value of the IP address field 401 of the RIPv2 packet 400 to obtain the IP address of the router 2, and the subnet ID extracting portion 4312 extracts the subnet ID from the obtained IP address of the router 2 referring to the value of the subnet mask field 402 of the RIPv2 packet 400.

For example, if 168.219.202.65 is recorded in the IP address field 401 of the RIPv2 packet and 255.255.255.192 is recorded in the IP subnet mask field 402, the router address obtaining portion 4311 reads 168.219.202.65, the value of the IP address field 401 of the RIPv2 packet 400, to obtain the IP address of 168.219.202.65 of the router 2, and the subnet ID extracting portion 4312 extracts the subnet ID of 168.219.202, which corresponds to a subnet mask of 255.255.255, from the obtained IP address of 168.219.202.65 of the router 2 referring to 255.255.255.192, which is the value of the IP address field 401 of the RIPv2 packet 400.

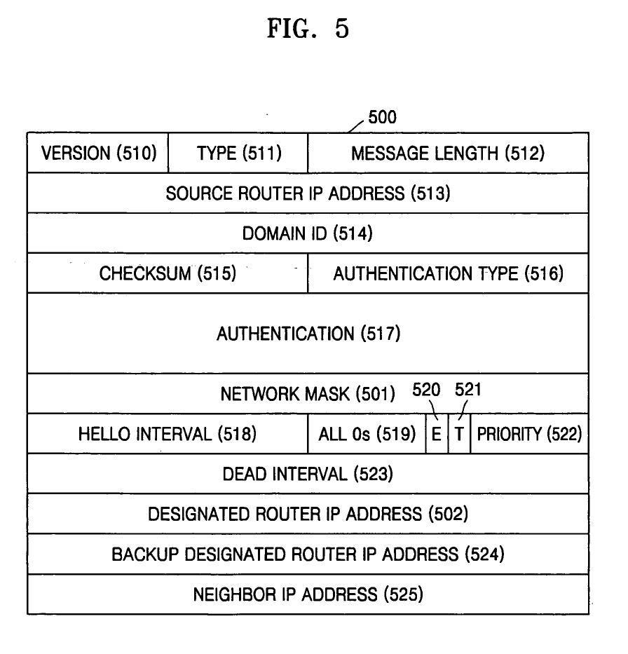

FIG. 5 is a diagram illustrating a format of an OSPF hello packet used for the exemplary embodiment of the present invention.

Referring to FIG. 5, the OSPF hello packet 500 includes a version field 510, a type filed 511, a message length field 512, a source router IP address field 513, a area ID field 514, a checksum field 515, an authentication type field 516, an authentication field 517, a network mask field 501, a hello interval field 518, an all 0s field 519, an E field 520, a T field 521, a priority field 522, a dead interval field 523, a designated router IP address field 502, a backup designated router IP address field 524, and a neighbour IP address field 525.

In the present exemplary embodiment, the network mask field 501 and the designated router IP address field 502 are referred to obtain the subnet ID. An IP address of a router is recorded in the designated router IP address field 502, and a subnet mask for extracting a subnet ID from the IP address is recorded in the network mask field 501.

That is, the router address obtaining portion 4311 reads the value of the designated router IP address field 502 of the OSPF hello packet 500 to obtain the IP address of the router 2, and the subnet ID extracting portion 4312 extracts the subnet ID from the obtained IP address of the router 2 referring to the value of the network mask field 501 of the OSPF hello packet 500.

For example, if 168.219.202.65 is recorded in the designated router IP address field 502 of the OSPF hello packet 500 and 255.255.255.192 is recorded in the network mask field 501, the router address obtaining portion 4311 reads 168.219.202.65, which is the value of the designated router IP address field 502 of the OSPF hello packet 500, to obtain the IP address of 168.219.202.65 of the router 2 and the subnet ID extracting portion 4312 extracts the subnet ID of 168.219.202, which corresponds to a subnet mask of 255.255.255, from the obtained IP address of 168.219.202.65 of the router 2 referring to 255.255.255.192, which is the value of the network mask field 501 of the OSPF hello packet 500.

The address configuring portion 432 configures an IP address not used by any of the nodes i.e., the node A 31, node B 32, node C 33, node D 41 and node E 42, on the subnet, among the IP addresses including the subnet ID obtained by the subnet ID obtaining portion 431 as an IP address of the node F 43. To avoid IP address conflict which may occur due to simultaneous use of a single IP address by several nodes, the address configuring portion 432 configures the IP address that the other nodes do not use as the IP address of the node F 43.

The address configuring portion 432 includes an address use inquiring portion 4321 and an address selecting portion 4322.

The address use inquiring portion 4321 inquires of all nodes whether all of the IP addresses including the subnet ID obtained by the subnet ID obtaining portion 431 are used. More specifically, the address use inquiring portion 4321 inquires of all nodes whether the nodes use the IP addresses by broadcasting Address Resolution Protocol (ARP) request packets which include the respective IP addresses including the subnet ID obtained by the subnet ID obtaining portion 431.

For example, if the IP address of the router 2 obtained by the router address obtaining portion 4311 is 168.219.202.65 and the subnet ID extracted by the subnet ID extracting portion 4312 is 168.219.202, the address use inquiring portion 4321 broadcasts 254 ARP request packets which include respective IP addresses (168.219.202.1 through 168.219.1.255) except 168.219.202.65 that is the IP address of the router. All the IP addresses include the subnet ID of 168.219.202.

The address selecting portion 4322 selects an address that none of the nodes use from all IP addresses based on the inquiry result of the address use inquiring portion 4321. More specifically, the address selecting portion 4322 selects the IP address that none of the nodes use by selecting an IP address included in an ARP request packet which does not respond to the inquiry.

For instance, if there is not an ARP response packet for the ARP request packet including 168.219.1.255 among the 254 ARP request packets broadcasted by the address use inquiring portion 4321, the address selecting portion 4322 selects 168.219.1.255 as the IP address of the node F 43.

An IP address and a physical network address of a destination node should be known to communicate via Internet. The ARP is a protocol used to obtain a physical network corresponding to the IP address when only the IP address, not the physical network address, of the destination node is known. The physical network address is generally a 48-bit address of an Ethernet card.

For example, when the node F 43 transmits an ARP request packet including a certain IP address to the node E 42, the node E 42 transmits an ARP response packet including a physical network address corresponding to the IP address. Thus, the IP address included in an ARP request packet which does not respond can be an IP address that none of the nodes use. In general, most ARP request packets do not respond. In this event, any IP addresses included in the ARP request packets that have not responded can be selected.

The IP address configured as the IP address of the node F 43 by the address configuring portion 432 is stored in the network information database 433 in order to be used as the IP address of the node F 43 in following communication procedures. When the node F 43 intends to communicate with other nodes, the node F 43 uses the IP address stored in the network information database 433.

The address monitor 434 monitors whether a node using an IP address identical to the IP address configured by the address configuring portion 432 as the IP address of the node F 43 connects to the subnet. When a node newly connected to the subnet has an IP address configured according to the present exemplary embodiment, the IP address conflict cannot occur, but when a user configures the IP address manually as in the first conventional method or automatically configures the IP address through a DHCP server as in the second conventional method, an IP address conflict can occur.

The address configuring portion 432 obtains an IP address other than the configured IP address based on the monitoring result of the address monitor 434 in the same fashion as described above.

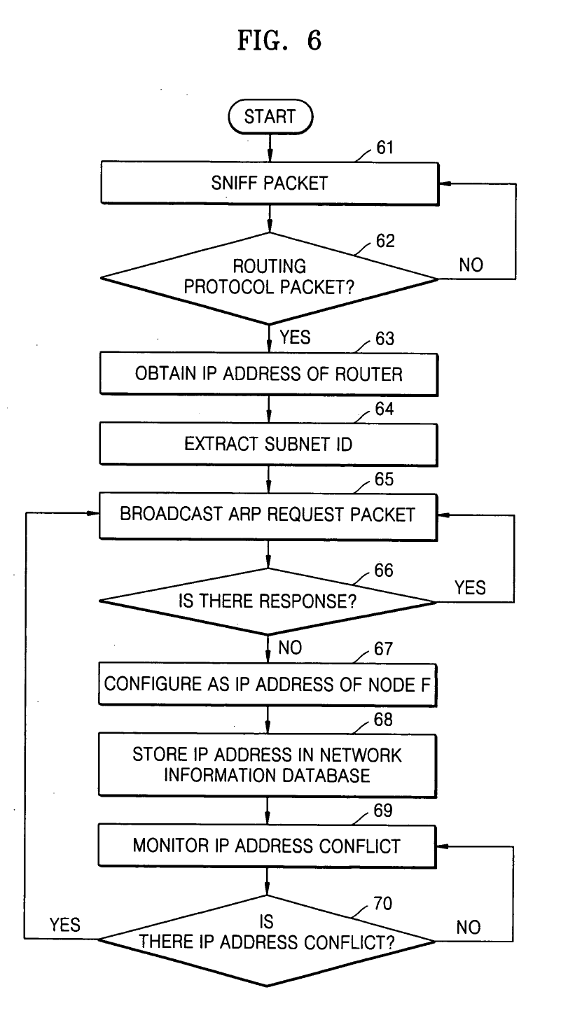

FIG. 6 is a flowchart illustrating a method of configuring an IP address according to an exemplary embodiment of the present invention.

Referring to FIG. 6, the method of configuring an IP address includes the operations below. The method of configuring an IP address is implemented in the IP address configuring apparatus of the node F 43 shown in FIG. 2. Accordingly, the above description related to the IP address configuring apparatus of the node F 43 will be applied to the method of configuring an IP address even though the description is omitted below.

In operation 61, the node F 43 sniffs a packet which is input thereto.

In operation 62, when the packet sniffed in operation 61 is a routing protocol packet, the node F 43 goes to operation 63, and, otherwise, goes back to operation 61.

In operation 63, the node F 43 reads the IP address of the router 2 included in the routing protocol packet to obtain the IP address of the router 2.

In operation 64, the node F 43 extracts the subnet ID from the IP address of the router 2 obtained in operation 63 referring to the subnet mask included in the routing protocol packet.

In operation 65, the node F 43 inquires of all nodes whether the IP addresses are used by broadcasting one of ARP request packets including respective IP addresses which include the subnet ID obtained in operation 64.

In operation 66, the node F 43 checks whether the ARP request packet broadcasted in operation 65 responds. When the ARP request packet responds, the node F 43 goes back to operation 65.

When the ARP request packet does not respond, in operation 67, the node F 43 selects an IP address that none of the nodes use by selecting the IP address included in the ARP request packet and configures the IP address as an IP address of the node F 43.

In operation 68, the node F 43 stores the IP address which is configured as the IP address of the node F 43 in operation 67 in the network information database 433 to be used as the IP address of the node F 43 in following communication procedures.

In operation 69, the node F 43 monitors whether a node using the same IP address as the IP address which was configured as the IP address of the node F 43 in operation 67 connects to the subnet. That is, the node F 43 monitors IP address conflicts.

In operation 70, when it is found that a node using the same IP address connects to the subnet in operation 69, that is, the IP address conflicts, the node F 43 goes back to operation 65 and obtains an IP address other than the configured IP address.

In addition to the above described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code. The code/instructions may form a computer program.

The computer readable code/instructions can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The medium may also be a distributed network, so that the computer readable code/instructions is stored/transferred and executed in a distributed fashion. The computer readable code/instructions may be executed by one or more processors.

According to the present invention, an IP address is automatically configured without the assistance of a network manager and a DHCP server, and therefore, the conventional problem to manually configure the IP address can be resolved. In particular, since a subnet ID is obtained from a routing protocol packet such as a RIPv2 packet or an OSPF hello packet without using a statistical method, an IP address of a node can be automatically configured in a network environment in which it is difficult to perform packet sniffing.

Furthermore, according to the present invention, an IP address that other nodes do not use is selected using ARP packets, and thus, even in a network environment in which the number of nodes not providing a ping response service is increasing, to avoid hacking an IP address of the node can be automatically and unmistakably (correctly) configured.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method of configuring an address of one of a plurality of nodes on a subnet, the method comprising the operations of:
obtaining an ID of the subnet from a packet transmitted from a router on the subnet; and
configuring an address that none of the nodes on the subnet use as the address of the one node among addresses including the obtained subnet ID.

2. The method of claim 1, wherein the operation of obtaining the ID of the subnet includes the operations of:
obtaining an address of the router from the packet transmitted from the router; and
extracting the subnet ID from the obtained address of the router.

3. The method of claim 1, wherein the packet is broadcasted to the nodes connected to the router so that the router can cyclically check changes in the subnet according to a predetermined routing protocol.

4. The method of claim 1, wherein the operation of configuring the address includes the operations of:
inquiring of the nodes on the subnet whether the nodes use the addresses including the obtained subnet ID; and
selecting the address that none of the nodes use among the addresses based on the inquiry result.

5. The method of claim 4, wherein the operation of inquiring of the nodes includes inquiring by broadcasting ARP (Address Resolution Protocol) request packets which include the respective addresses and the operation of selecting the address includes selecting an address included in an ARP request packet which does not respond among the ARP request packets.

6. The method of claim 1, further comprising the operation of:
monitoring whether a node using an address identical to the address connects to the subnet,
wherein the operation of obtaining the ID of the subnet includes obtaining an address other than the address according to the monitoring result.

7. An apparatus for configuring an address of a node on a subnet, the apparatus comprising:
a subnet ID obtaining portion obtaining an ID of the subnet from a packet transmitted from a router on the subnet; and
an address configuring portion configuring an address that none of a plurality of nodes on the subnet use, as the address of the node among addresses including the obtained subnet ID.

8. The apparatus of claim 7, wherein the subnet ID obtaining portion includes:
a router address obtaining portion obtaining an address of the router from the packet transmitted from the router; and
a subnet ID extracting portion extracting the subnet ID from the address of the router obtained by the router address obtaining portion.

9. The apparatus of claim 7, wherein the packet is broadcasted to the nodes connected to the router so that the router can cyclically check changes in the subnet according to a predetermined routing protocol.

10. The apparatus of claim 7, wherein the address configuring portion includes:
an address use inquiring portion inquiring of the nodes whether the nodes use the addresses including the obtained subnet ID; and
an address selecting portion selecting the address that none of the nodes use among the addresses including the obtained subnet ID based on the inquiry result of the address use inquiring portion.

11. The apparatus of claim 10, wherein the address use inquiring portion inquires by broadcasting ARP request packets which include the respective addresses and the address selecting portion selects an address included in an ARP request packet which does not respond among the ARP request packets.

12. The apparatus of claim 7, further comprising:
an address monitor monitoring whether a node using an address identical to the address connects to the subnet,
wherein the address configuring portion obtains an address other than the address according to the monitoring result of the address monitor.

13. A computer readable recording medium having embodied thereon a computer program for executing a method of configuring an address of one of a plurality of a node on a subnet, the method comprising the operations of:
obtaining an ID of the subnet from a packet transmitted from a router on the subnet; and
configuring an address that none of nodes on the subnet use as the address of the one node among addresses including the obtained subnet ID.

14. A method of configuring an address of one of a plurality of nodes on a subnet, comprising:
obtaining a subnet ID from a packet on the subnet; and
configuring an address that none of the nodes on the subnet use, as the address of the one node among addresses including the obtained subnet ID.

15. At least one computer readable medium storing instructions that control at least one processor to perform a method of configuring an address of a plurality of nodes on a subnet, the method comprising:
obtaining a subnet ID from a packet on the subnet; and
configuring an address that none of the nodes on the subnet use, as the address of the one node among addresses including the obtained subnet ID.
